(19) United States
(12) Patent Application Publication
(10) Pub. No.: US 2021/0391812 A1
(43) Pub. Date: Dec. 16, 2021

(54) POSITION SENSOR OFFSET ERROR DIAGNOSIS AND CALIBRATION IN PERMANENT MAGNET SYNCHRONOUS MACHINE

(71) Applicant: Saginaw Valley State University, University Center, MI (US)

(72) Inventors: Sandun Shivantha Kuruppu, Saginaw, MI (US); Yu Zou, Saginaw, MI (US)

(21) Appl. No.: 17/340,202

(22) Filed: Jun. 7, 2021

Related U.S. Application Data
(60) Provisional application No. 63/038,393, filed on Jun. 12, 2020.

(51) Int. Cl. H02P 6/16; G01D 5/14

(52) U.S. Cl. CPC H02P 6/16; H02P 2103/20; G01D 5/145

(57) ABSTRACT

A method of detecting angular position sensor offset mar (PSOE) in a permanent magnet synchronous machine operated from a closed-loop field oriented control and controller adapted to detect PSOE in a permanent magnet synchronous machine, includes sensing an electrical parameter of a machine drive current with a sensor from a location on the closed-loop field oriented control and comparing the electrical parameter with machine commands provided to the closed-loop field oriented control. It is determined that a PSOE has occurred from the comparing.

### CROSS REFERENCE TO RELATED APPLICATION

The present application claims priority of U.S. provisional application Ser. No. 634038,393 filed Jun. 12, 2020 by Kuruppu et al for Position Sensor Offset Error Diagnosis, Quantification and Calibration, which is hereby incorporated herein by reference in its entirety.

### BACKGROUND AND FIELD OF THE INVENTION

The present invention is directed to an error detection and correction method, system and computer program in a permanent magnet synchronous machine (PMSM) and, in particular, for diagnosis, quantification and calibration of angular position sensor offset error (PSOE).

PMSM's are in the forefront due to high power density, efficiency and torque density. The PMSM consists of permanent magnets mounted on the rotating part of the motor, referred to as a rotor, with stator field established by AC currents through field windings, referred to as the stator. The machine may be a motor or generator, or used interchangeably for both, such as in an electric or hybrid vehicle where the machine acts as a motor to propel the vehicle from energy stored in a battery and as a generator to return electrical energy to the battery to brake the vehicle. The rotor may rotate in the center of the stator or around the stator.

Angular orientation of the fields generated by the rotor and stator is key in generating the desired torque with appropriate polarity (clockwise and counterclockwise). An angular positon sensor, or just position sensor, is used to sense relative angular alignment of the rotor flux vector to properly orient the stator field. Various types of such positons sensors are known and are alternatively referred to as resolvers, encoders, hall effect sensor, or analog hall sensors, or the like. These position sensors are mechanically mounted to the rotation shaft and has the potential to be mis-calibrated during operation or become misaligned with the rotor during use. Such PSOE could impede normal operation or, in the extreme cause the machine to rotate in an opposite direction with possible catastrophic results. At a minimum, the control algorithm receives incorrect rotor position resulting in a non-optimal placement of stator flux and further resulting in incorrect output torque.

Various techniques have been proposed for sensing PSOE. They typically require PMSM to be taken out of use which preclude them from servicing as a failure warning detection technique.

### SUMMARY OF THE INVENTION

The present invention provides a technique for detection as well as quantification of PSOE. It also provides an automatic calibration technique for the PSOE either in-system or at any stage of product development without external hardware. The technique may be performed while the machine is in operation in order to detect and alert to a failure. It can be carried out without additional hardware. It can be implemented with computer code that is run on the same processor that is operating the PMSM with minimal modification to the programmed use for normal operation.

A method of detecting PSOE in a permanent magnet synchronous machine operated from a closed-loop field oriented control and controller adapted to detect the PSOE in a permanent magnet rotating machine [SSK1], according to an aspect of the invention, includes sensing an electrical parameter of a machine drive current with a sensor. The electrical parameter is sensed at a location on the closed-loop field oriented control. The electrical parameter is with machine commands provided to the closed-loop field oriented control. It is determined if PSOE has occurred from the comparing.

The electrical parameter may be a voltage such as a voltage [SSK2] error along the d-axis and q-axis. The voltage error may be the difference between estimated voltages and the output voltages of the PI controllers. The error voltages may be a trigonometric function of PSOE.

The electrical parameter may be a current such as a current error along the d-axis and q-axis. The current error may be the difference between estimated currents and the command currents. The estimated currents may be trigonometric functions of position sensor offset error. The current error calculation may involve a non-linear mapping to correct for system non-linearities.

The determining may use rotor reference frame transformed variables. The amount of offset error may be quantified. An indication if the amount of offset error exceeds a threshold may be provided. The offset error may be determined while the machine is in operation. The method may be performed with computer programming code operating on a controller comprising the closed-loop field oriented control.

These and other objects, advantages, purposes and features of this invention will become apparent upon review of the following specification in conjunction with the drawings.

### BRIEF DESCRIPTION OF THE DRAWINGS

FIG. 1 is a block diagram of an electronic circuit layout for a permanent magnet synchronous machine drive circuit;

FIG. 2 is a block diagram of a field oriented control closed loop feedback system with voltage-based position error quantification implementation;

FIG. 3 is a block diagram of a field oriented control closed loop feedback system with current-based position error quantification implementation;

FIG. 4 is a flow diagram for a process for voltage-based position error quantification shown in FIG. 2; and

FIG. 5 is a flow diagram for a process for current-based position error quantification shown in FIG. 3.

### DESCRIPTION OF THE PREFERRED EMBODIMENTS

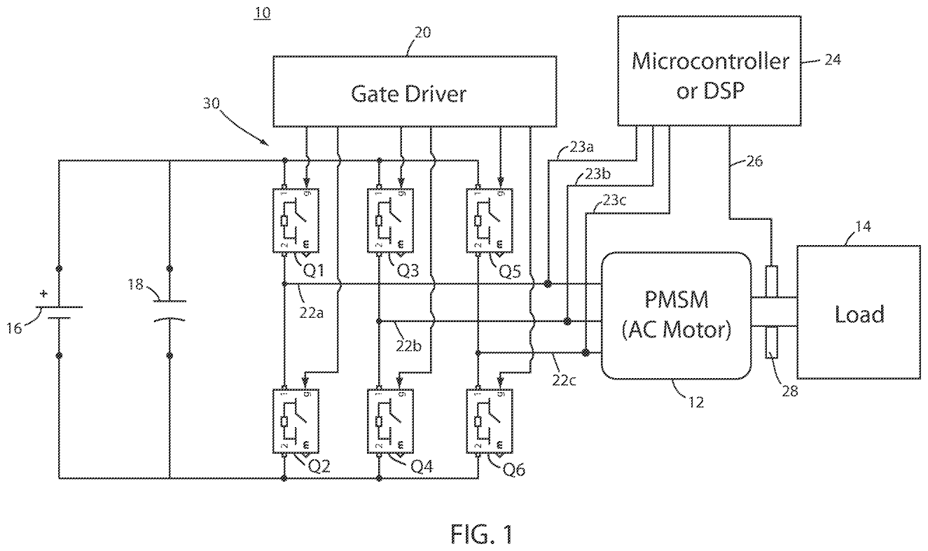

The present invention will now be described with reference to the accompanying figures, wherein the numbered elements in the following written description correspond to like-numbered elements in the figures. A permanent magnet synchronous machine (PMSM) 12 is electrically driven from an inverter system 10 to propel a load 14 or as a torque/speed/position actuator as shown in FIG. 1. Electrical energy to operate PMSM drive system 10 is supplied from an electrical supply 16, such as a battery or other source. A capacitor 18 smooths and ripples in the supply voltage provided to multi-phase inverter 20 which is three-phase in the illustrated embodiment. Inverter 20 supplies output drive currents to PMSM 12, which is a three-phase permanent magnet machine, on lines 22a, 22b and 22c. Such output drive currents can be monitored by a controller 24 over lines 23a, 22b, and 22c. Controller 24 also receives rotor position and speed information on a line 26 from a position sensor 28. Connected with PMSM 12.

As is conventional, inverter 30 is made up of three parallel line, each made up of two serially connected switching elements Q1-Q6 each with an anti-parallel diode. On/off states of switching elements Q1-Q6 are controlled from a gate driver 20. A midpoint of each pair of switching elements is connected with one of outputs 22a, 22h, and 22c then to a respective stator winding of PMSM 12. Switching elements Q1-Q6 are semiconductor devices, such as metal oxide semiconductor field effect transistors (MOSFET) or the like.

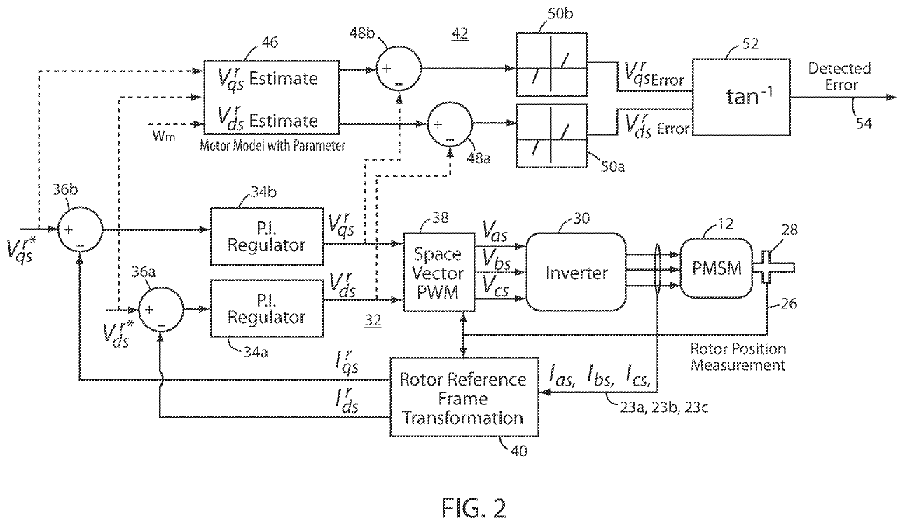

Controller 24 is programmed to carry out a filed oriented control (FOC) 32 in conjunction with inverter 30 to operate PMSM 12 as shown in FIG. 2. A current command generating unit (not shown) generates a d-axis current command value I′_{ds} and a q-axis current command value I′_{qs} based on a torque command value supplied to the current command generating unit. Proportional/integral regulators 34a, 34b obtain control deviations by performing PI operation on respective error calculations 36a, 36b using a predetermined gain and generate a d-axis voltage command V′_{ds} and a q-axis voltage command V′_{qs} based on control deviation. A combination coordinate conversion and pulse-width-modulation (PWM) signal generating unit 38 generates switching control signals Vₐₛ, V_{bs} and V_{cs} provided to gate drive 20 of inverter 30 based on a comparison between the three-phase voltage command values Vₐₛ, V_{bs} and V_{cs} and a predetermined carrier wave signal. A rotor reference frame transformation 40 calculates a d-axis current I′_{ds} and a q-axis current I′_{qs} based on the phase currents monitored on lines 23a, 23b, 23c through coordinate conversion (three-phases to two-phases using a rotor position signal from line 26. A deviation of the d-axis current from the command value I′_{ds} is input from summation 36a to PI regulator 34a. A deviation of the q-axis current from the command value I′_{qs} is input from summation 36b to PI regulator 34b. In this way, FOC 32 is a closed loop for controlling the motor currents to the current command values so the output torque of the PMSM 12 is controlled in accordance with torque commands provided by the current command generating unit (not shown).

Primary control of the PMSM 12 is by FOC 32 where position sensor 28 is used for rotor position measurement. The sensor's relative alignment with respect to the rotor flux vector is essential to properly orient the stator field. Position sensor 28 is mechanically mounted to rotation shaft of PMSM 12, The mechanical interface has a tendency to fail/loosen due to vibration, shock and other environmental conditions causing the sensor to loose alignment, referred to as position sensor offset error (PSOE). A change in alignment will impede normal operation introducing a torque reduction and, under severe effort, the system could reach zero torque or torque reversal.

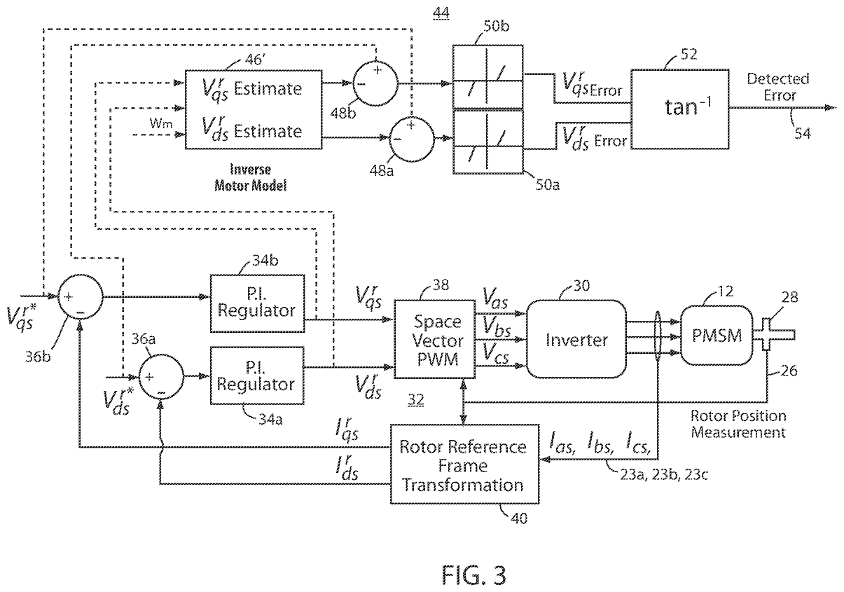

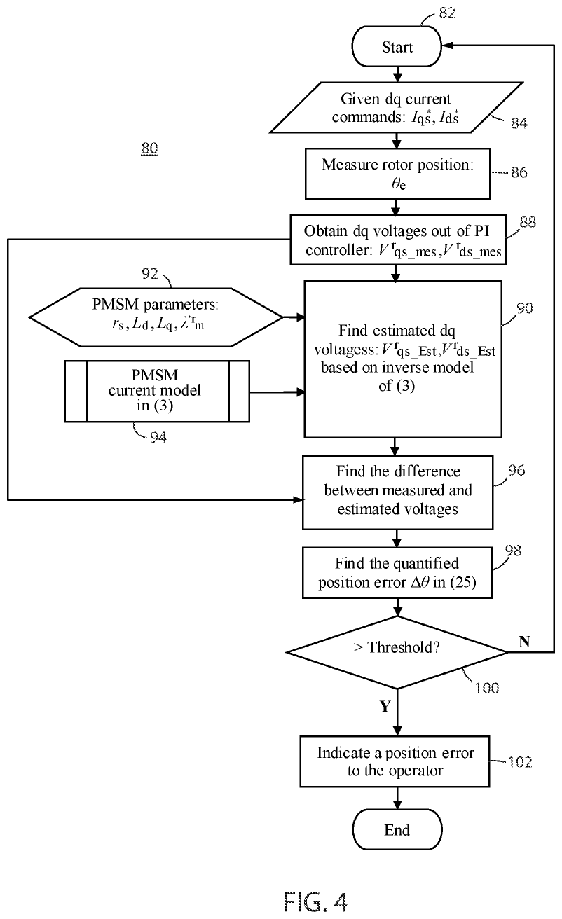

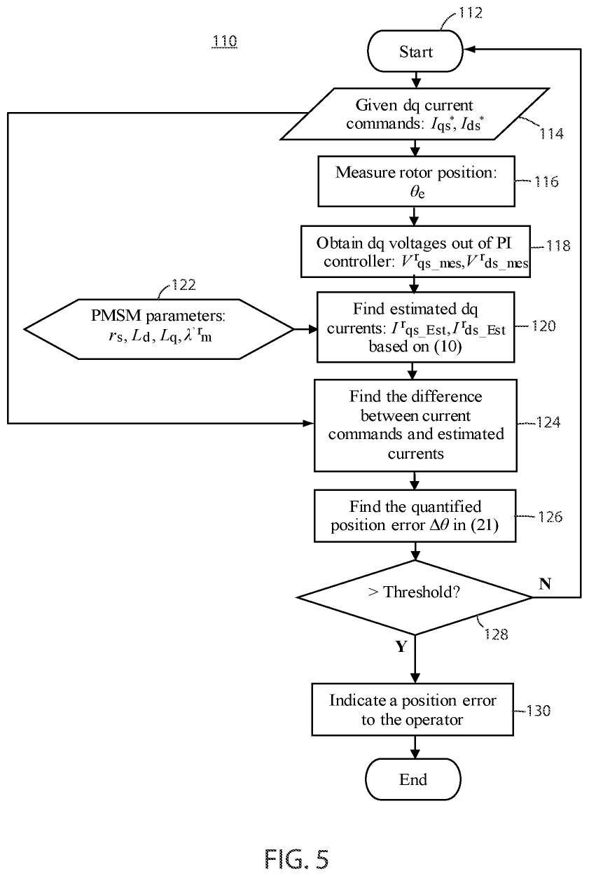

Detection of such failure, quantification of the amount of offset and/or providing a calibration of the positon sensor offset error may be obtained either in-system or at any stage of product development without external hardware by an estimate function. The estimate function is carried out, in the illustrated function, by a computer program that runs along with FOC 32 in controller 24. Of course the estimate function could operate on its own controller or be carried out by known equivalents. The estimate function can be either a voltage estimate function 42 shown in FIGS. 2 and 4 or a current estimate function 44 shown in FIGS. 3 and 5 or a combination of the two. In voltage estimate function 42, estimated variables in the form of estimated voltages along the d-axis and q-axis are developed/defined in such way that the difference between the estimated voltages and the output voltages PI controllers 34a, 34b are trigonometry functions of PSOE. Thus, PSOE can be quantified by the inverse trigonometry function of this difference. In the current estimate function 44 the estimated variables are estimated currents along the d-axis and q-axis which are developed/defined in such way that the difference between them and the command currents are trigonometry functions of PSOE. Thus, PSOE can be detected and/or quantified by the inverse trigonometry function of this difference.

Computer code for carrying out voltage estimate function 42, as shown in FIG. 2 is integrated with the code that carries out FOC 32 on controller 24. Voltage estimate function 42 includes a voltage estimator 46 that samples the current commands I′_{qs} and I′_{ds} and compares them at 48a and 48b with the respective outputs V′_{qs} of PI regulator 34b and V′_{ds} of PI regulator 34a. The current commands represent the desired torque of PMSM 12 and the outputs of the PI regulators are a function of the actual currents and, hence, torque produced by PMSM 12. Outputs of comparators 48a and 48b are passed through respective threshold detection functions 50a and 50b to ensure that noise does not get input to inverse tangent function 52. The resulting error signals V′_{qs error} along the q axis and V′_{ds error} along the d axis are provided to inverse tangent function 52 that produces an output error reading 54. Output error reading 54 can be used to produce a fault signal to an operator if it exceeds a threshold. Since it is a function of PSOE it proves a quantification of the amount of error angle.

Referring to FIG. 4, a voltage-based error quantification flowchart 80 starts an iteration at 82 by obtaining current commands I′_{qs} and I′_{ds} at 84 and measuring the rotor position at 86 from line 26. PI controller output voltages V′_{qs} and V′_{ds} are obtained at 88. Estimated voltages V′_{qs} and V′_{ds} are determined at 90 in a manner set forth below considering parameters of the PMSM at 92. A difference between the dq voltages obtained at each axis at 88 and the estimated dq voltages determined at 90 are compared by 48a and 48b at 96 and the error voltages V′_{qs error} and V′_{ds error} presented to the inverse tangent function at 98 to find the quantified PSOE at 98 on output 54. If the PSOE exceeds a given threshold value at 100 a positon error indication is presented to the operator at 102. If the PSOE does not exceed the threshold, another iteration is begun at 82.

The estimated dq voltages can be obtained using simplified block diagram representation of FOC system 32 as follows:

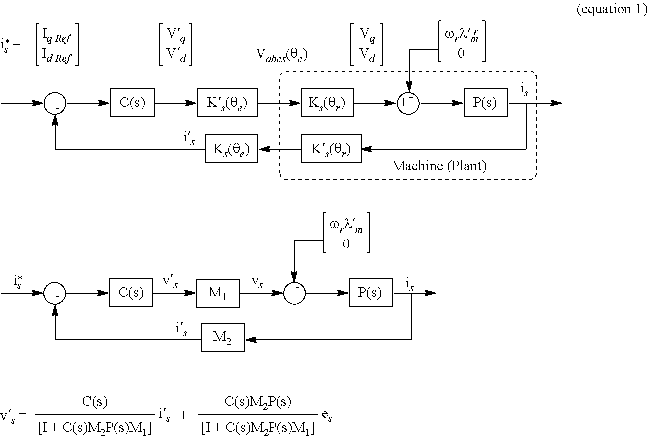

To simplify the analysis, a surface mount PMSM is considered with zero d-axis current. Therefore, equation (1) can be simplified as (2) under the steady state condition (t→∞, s→0). Steady state condition is considered here as the fault detection need to be robust to avoid false positives during transients. A non-salient machine is considered resulting in L_{d}≈L_{q}. θᵣ−θₒ=Δθ.

$$[ \begin{matrix}{V}_{q {s}_{-} m e s}^{r} \\ {V}_{{ds}_{-} mes}^{r}\end{matrix} ] = [ \begin{matrix}{r}_{s} \\ - {ω}_{r} {L}_{q}\end{matrix} ] [ \begin{matrix}{I}_{q {s}_{-} R e f}^{r} \\ {I}_{{ds}_{-} R e f}^{r}\end{matrix} ] + [ \begin{matrix}cos ( Δθ ) \\ - s in ( Δθ )\end{matrix} ] {ω}_{r} {{λ}^{′}}_{m}^{r} \qquad ( equation 2 )$$

These measured rotor reference frame voltages are then applied to the steady state PMSM model to obtain the estimated rotor reference frame voltages as shown below in equation (3).

$$[ \begin{matrix}{V}_{q {s}_{-} Est}^{r} \\ {V}_{{ds}_{-} Est}^{r}\end{matrix} ] = [ \begin{matrix}{r}_{s} & {ω}_{r} {L}_{d} \\ - {ω}_{r} {L}_{q} & {r}_{s}\end{matrix} ] [ \begin{matrix}{I}_{q {s}_{-} R e f}^{r} \\ {I}_{{ds}_{-} R e f}^{r}\end{matrix} ] + [ \begin{matrix}{ω}_{r} {{λ}^{′}}_{m}^{r} \\ 0\end{matrix} ] \qquad ( equation 3 )$$

Error between the estimated rotor reference frame voltages and measured voltages Rotor Reference Frame Voltage Error result in the following relationship.

$$[ \begin{matrix}{V}_{q {s}_{-} Err}^{r} \\ {V}_{{ds}_{-} Err}^{r}\end{matrix} ] = [ \begin{matrix}{V}_{q {s}_{-} Est}^{r} - {V}_{q {s}_{-} mes}^{r} \\ {V}_{{ds}_{-} Est}^{r} - {V}_{{ds}_{-} mes}^{r}\end{matrix} ] = [ \begin{matrix}{ω}_{r} {{λ}^{′}}_{m}^{r} ( 1 - cos ( Δθ ) ) \\ {ω}_{r} {{λ}^{′}}_{m}^{r} sin ( Δθ )\end{matrix} ] \qquad ( equation 4 )$$

Using trigonometric identities, above relationship reduces to the relationship shown in equation (5).

$$[ \begin{matrix}{V}_{q {s}_{-} Est}^{r} - {V}_{q {s}_{-} mes}^{r} \\ {V}_{{ds}_{-} Est}^{r} - {V}_{{ds}_{-} mes}^{r}\end{matrix} ] = [ \begin{matrix}2 {ω}_{r} {{λ}^{′}}_{m}^{r} {sin}^{2} ( Δθ / 2 ) \\ 2 {ω}_{r} {{λ}^{′}}_{m}^{r} sin ( Δθ / 2 ) cos ( Δ θ / 2 )\end{matrix} ] \qquad ( equation 5 )$$

Therefore, the ratio between the rotor reference frame voltages are found as,

$$Δ θ = 2 {tan}^{- 1} \{ \frac{[ {V}_{q {s}_{-} Est}^{r} - {V}_{q {s}_{-} mes}^{r} ]}{[ {V}_{{ds}_{-} Est}^{r} - {V}_{{ds}_{-} mes}^{r} ]} \} \qquad ( equation 6 )$$

Alternatively, a similar result can be obtained without fully computing the rotor reference frame voltages.

$$[ \begin{matrix}{V}_{q {s}_{-} mes}^{r} - {r}_{s} {I}_{q {s}_{-} R e f}^{r} \\ {V}_{{ds}_{-} mes}^{r} + {ω}_{r} {L}_{q} {I}_{q {s}_{-} R e f}^{r}\end{matrix} ] = [ \begin{matrix}cos ( Δθ ) \\ - s in ( Δθ )\end{matrix} ] {ω}_{r} {{λ}^{′}}_{m}^{r} \qquad ( equation 7 )$$

Induced position error can be obtained by taking the ratio of the above two equations as shown below.

Δθ=tan⁻¹(−[V_{ds_mes}^{r}+ωᵣL_{q}I_{qs_Ref}^{r}]/[V_{qs_mes}^{r}−rₛI_{qs_Ref}^{r}]) (equation 8)

Equations (6) and (8) are both capable of finding PSOE.

For current estimate function 44 shown in FIG. 3, an estimate function 46′ estimates currents along the d-axis and q-axis which are developed/defined in such way that the difference between them and the command currents are trigonometry functions of PSOE. Thus, PSOE can be detected and/or quantified by the inverse trigonometry function of this difference. Otherwise the current-based position error quantification has the same logic components as voltage-based,

Referring to FIG. 5, for dq current commands at 114, the rotor position is measured at 116 and the dq voltages from the FT controllers are sampled at 118. Estimated dq currents are determined at 120 as set forth below and compared with the current commands at 124. FSOE is determined at 126 and compared with a threshold at 128. If the PSOE exceeds the threshold at 128 the operator is presented with an indication. If not, another iteration is performed starting at 112. The current based method follows.

$${{ν}^{′}}_{s} = \frac{C ( s )}{[ I + C ( s ) {M}_{2} P ( s ) {M}_{1} ]} {i}_{s}^{′} + \frac{C ( s ) {M}_{2} P ( s )}{[ 1 + C ( s ) {M}_{2} P ( s ) {M}_{1} ]} {e}_{s} \qquad ( equation 1 )$$

To simplify the analysis, a surface mount FMSM is considered with zero d-axis current. Therefore, under the steady state condition (t→∞, s→0) the following relationship is derived. Steady state condition is considered here as the fault detection need to be robust to avoid false positives during transients. A non-salient machine is considered resulting in L_{d}≈L_{q}. θᵣ−θₒ=Δθ.

$$\begin{matrix}[ \begin{matrix}{V}_{q {s}_{-} m e s}^{r} \\ {V}_{{ds}_{-} mes}^{r}\end{matrix} ] = [ \begin{matrix}{r}_{s} \\ - {ω}_{r} {L}_{q}\end{matrix} ] {i}_{qs}^{r *} + [ \begin{matrix}cos ( Δθ ) \\ - s in ( Δθ )\end{matrix} ] {ω}_{r} {{λ}^{′}}_{m}^{r} & ( equation 9 ) \\ [ \begin{matrix}{I}_{q {s}_{-} Est}^{r} \\ {I}_{{ds}_{-} Est}^{r}\end{matrix} ] = {[ \begin{matrix}{r}_{s} & {ω}_{r} {L}_{d} \\ - {ω}_{r} {L}_{q} & {r}_{s}\end{matrix} ]}^{- 1} [ \begin{matrix}{V}_{q {s}_{-} m e s}^{r} \\ {V}_{{ds}_{-} mes}^{r}\end{matrix} ] - {[ \begin{matrix}{r}_{s} & {ω}_{r} {L}_{d} \\ - {ω}_{r} {L}_{q} & {r}_{s}\end{matrix} ]}^{- 1} [ \begin{matrix}{ω}_{r} {{λ}^{′}}_{m}^{r} \\ 0\end{matrix} ] & ( equation 10 ) \\ [ \begin{matrix}{I}_{q {s}_{-} Est}^{r} \\ {I}_{{ds}_{-} Est}^{r}\end{matrix} ] = {[ \begin{matrix}{r}_{s} & {ω}_{r} {L}_{d} \\ - {ω}_{r} {L}_{q} & {r}_{s}\end{matrix} ]}^{- 1} [ [ \begin{matrix}{r}_{s} \\ - {ω}_{r} {L}_{q}\end{matrix} ] {i}_{qs}^{r *} + [ \begin{matrix}cos ( Δθ ) \\ - s in ( Δθ )\end{matrix} ] {ω}_{r} {{λ}^{′}}_{m}^{r} ] - {[ \begin{matrix}{r}_{s} & {ω}_{r} {L}_{d} \\ - {ω}_{r} {L}_{q} & {r}_{s}\end{matrix} ]}^{- 1} [ \begin{matrix}{ω}_{r} {{λ}^{′}}_{m}^{r} \\ 0\end{matrix} ] & ( equation 11 ) \\ {I}_{q {s}_{-} Est}^{r} = {i}_{qs}^{r *} - \frac{{ω}_{r} {{λ}^{′}}_{m}^{r}}{( {{ω}_{r}}^{2} {{L}_{q}}^{2} + {{r}_{s}}^{2} )} [ {ω}_{r} {L}_{q} s in ( Δθ ) + {r}_{s} cos ( Δθ ) ] - \frac{{ω}_{r} {{λ}^{′}}_{m}^{r} {r}_{s}}{( {{ω}_{r}}^{2} {{L}_{q}}^{2} + {{r}_{s}}^{2} )} & ( equation 12 ) \\ {I}_{q {s}_{-} Est}^{r} = \frac{{ω}_{r} {{λ}^{′}}_{m}^{r}}{( {{ω}_{r}}^{2} {{L}_{q}}^{2} + {{r}_{s}}^{2} )} [ {r}_{s} s in ( Δθ ) - {ω}_{r} {L}_{q} cos ( Δθ ) ] - \frac{{{ω}_{r}}^{2} {{λ}^{′}}_{m}^{r} {L}_{q}}{( {{ω}_{r}}^{2} {{L}_{q}}^{2} + {{r}_{s}}^{2} )} & ( equation 13 )\end{matrix}$$

The above relationship is reformulating by substituting

$$\begin{matrix}sin ( α ) = \frac{{ω}_{r} {L}_{q}}{\sqrt{{{L}_{q}}^{2} {{ω}_{r}}^{2} + {{r}_{s}}^{2}}} and cos ( α ) = \frac{{r}_{s}}{\sqrt{{{L}_{q}}^{2} {{ω}_{r}}^{2} + {{r}_{s}}^{2}}} & ( equation 14 ) \\ {I}_{{qs}_{-} Est}^{r} = {i}_{qs}^{r *} - \frac{{ω}_{r} {{λ}^{′}}_{m}^{r}}{\sqrt{( {{ω}_{r}}^{2} {{L}_{q}}^{2} + {{r}_{s}}^{2} )}} [ cos ( α ) - cos ( Δθ - α ) ] & ( equation 15 ) \\ {I}_{q {{s}_{-}}_{E} st}^{r} = \frac{- {ω}_{r} {{λ}^{′}}_{m}^{r}}{\sqrt{( {{ω}_{r}}^{2} {{L}_{q}}^{2} + {{r}_{s}}^{2} )}} [ sin ( α ) - sin ( Δθ - α ) ] & ( equation 16 )\end{matrix}$$

Given the parameters rₛ, L_{q} and λₘ^{′r}, angle α is negligible. Therefore, the relationship shown in equations above reduce to the following when α→O. This relationship is clearly visible in the estimator output waveforms.

$$\begin{matrix}{i}_{qs}^{r *} - {I}_{q {s}_{Est}}^{r} \approx \frac{{ω}_{r} {{λ}^{′}}_{m}^{r}}{\sqrt{( {{ω}_{r}}^{2} {{L}_{q}}^{2} + {{r}_{s}}^{2} )}} [ 1 - cos ( Δθ ) ] & ( equation 17 ) \\ {I}_{q {s}_{E} st}^{r} \approx \frac{- {ω}_{r} {{λ}^{′}}_{m}^{r}}{\sqrt{( {{ω}_{r}}^{2} {{L}_{q}}^{2} + {{r}_{s}}^{2} )}} [ sin ( Δθ ) ] & ( equation 18 )\end{matrix}$$

In order to quantify the PSOE, these current estimation errors are reformulated as follows using basic trigonometric identities. Here, θᵣ−θₒ=Δθ or also stated as θₒ−θᵣ=−Δθ.

$$\begin{matrix}{i}_{qs}^{r *} - {I}_{q {s}_{-} Est}^{r} = \frac{{ω}_{r} {{λ}^{′}}_{m}^{r}}{\sqrt{( {{ω}_{r}}^{2} {{L}_{q}}^{2} + {{r}_{s}}^{2} )}} [ sin ( \frac{- Δ θ}{2} ) sin ( \frac{2 α - Δ θ}{2} ) ] & ( equation 19 ) \\ 0 - {I}_{{ds}_{-} Est}^{r} = \frac{- 2 {ω}_{r} {{λ}^{′}}_{m}^{r}}{\sqrt{( {{ω}_{r}}^{2} {{L}_{q}}^{2} + {{r}_{s}}^{2} )}} [ sin ( \frac{- Δ θ}{2} ) cos ( \frac{2 α - Δ θ}{2} ) ] & ( equation 20 ) \\ \frac{[ {I}_{q {s}_{Est}}^{r} - {i}_{qs}^{r *} ]}{[ {I}_{{ds}_{-} Est}^{r} ]} = tan ( \frac{2 α - Δ θ}{2} ) & ( equation 21 ) \\ Δθ = 2 α - 2 {tan}^{- 1} \{ \frac{[ {I}_{{ds}_{-} Est}^{r} ]}{[ {I}_{q {s}_{Est}}^{r} - {i}_{qs}^{r *} ]} \} & ( equation 22 )\end{matrix}$$

Equation 22 represents the PSOE.

The techniques disclosed above are capable of detecting and quantifying PSOE occurrences during machine operation. The same techniques can be used for PSOE during the machine production process. This can be accomplished without extra hardware and without requiring a locked rotor condition. Calibration can be obtained in open loop or closed loop current control using either voltage or current estimating functions or a combination or both.

Changes and modifications in the specifically described embodiments can be carried out without departing from the principles of the present invention which is intended to be limited only by the scope of the appended claims, as interpreted according to the principles of patent law including the doctrine of equivalents.

### NOMENCLATURE

ψ_{Stator}, ψ_{Rotor} Stator and rotor flux vectors
θₑ Measured rotor position subjected to error
θ_{offset} Total position measurement alignment error
Δθ Position sensor alignment error
θ_{f} Angle between stator and rotor flux vectors
Tₑₘ Electromagnetic torque
V̅ᵣ, V̅_{bs}, V̅_{cs} Phase voltage for A, B and C phases
Īₐₛ, Ī_{bs}, Ī_{cs} Phase currents for A, B and C phases
Ēₐₛ Phase A back EMF
ωᵣ Rotor speed
Rₛ Phase resistance
L_{q}, L_{d} Quadrature and direct axis inductances
λₘ^{′r} Magnitude of the flux linkage
θᵣ True rotor position
θᵥ₁, θᵥ₂ Voltage angles
i_{qs}^{r}, i_{ds}^{r} Dynamic rotor reference frame currents
I_{qs}^{r}, I_{ds}^{r} Steady state rotor reference frame currents
i_{qs_Bst}^{r}, I_{ds_Est}^{r} Estimated rotor reference frame currents
v_{qs}^{r}, v_{ds}^{r} Dynamic rotor reference frame voltages
V_{qs_Mes}^{r}, V_{ds_Mes}^{r} Measured rotor reference frame voltages
Kₚ,Kₗ Proportional and integral gains for controllers
s Laplace variable

The embodiments of the invention in which an exclusive property or privilege is claimed are defined as follows:

1. A method of detecting angular position offset error (PSOE) in a permanent magnet synchronous machine operated from a closed-loop field oriented control, comprising:
sensing an electrical parameter of a machine drive current with a sensor from a location on the closed-loop field oriented control;
comparing the electrical parameter with machine commands provided to the closed, loop field oriented control; and
determining that a PSOE has occurred from said comparing.

2. The method of detecting as claimed in claim 1 wherein said electrical parameter comprises a voltage.

3. The method of detecting as claimed in claim 2 wherein the electrical parameter comprises voltages along the d-axis and q-axis which are obtained from the difference between the estimated voltages and output voltages of the P1 controllers or voltages applied to the machine.

4. The method of detecting as claimed in claim 3 wherein the estimated voltages are trigonometry functions of PSOE.

5. The method of detecting as claimed in claim 1 wherein said electrical parameter comprises a current.

6. The method of detecting as claimed in claim 5 wherein the electrical parameter comprises currents along the d-axis and q-axis which are obtained from the difference between the estimated currents and the commanded currents.

7. The method of detecting as claimed in claim 6 wherein the estimated currents are trigonometry functions of PSOE.

8. The method of detecting as claimed in claim 1 wherein said determining uses rotor reference frame transformed variables.

9. The method as claimed in claim 1 including quantifying amount of PSOE.

10. The method as claimed in claim 9 including providing an indication if the amount of PSOE exceeds a threshold.

11. The method as claimed in claim 1 performed while the machine is in operation.

12. The method as claimed in claim 1 performed with computer programming code operating on a controller comprising the closed-loop field oriented control.

13. A controller adapted to detect angular position offset error (PSOE) in a permanent magnet synchronous machine, comprising:
a closed-loop field oriented control machine adapted to produce at least one machine drive current;
a sensor adapted to sense an electrical parameter of an actual machine drive current from a location on the closed-loop field oriented control;
a comparator adapted to compare the electrical parameter with machine commands provided to the closed-loop field oriented control; and
said controller determining that a PSOE has occurred from an output of said comparing.

14. The controller as claimed in claim 13 wherein said electrical parameter comprises a voltage.

15. The controller as claimed in claim 14 wherein the electrical parameter comprises voltages along the d-axis and q-axis which are obtained from the difference between the estimated voltages and output voltages of P1 controllers or voltages applied to the machine.

16. The controller as claimed in claim 15 wherein the estimated voltages are trigonometry functions of PSOE.

17. The controller as claimed in claim 13 wherein said electrical parameter comprises a current.

18. The controller as claimed in claim 17 wherein the electrical parameter comprises currents along the d-axis and q-axis which are obtained from the difference between the estimated currents and the command currents.

19. The controller as claimed in claim 18 wherein the estimated currents are trigonometry functions of PSOE.

20. The controller as claimed in claim 1 wherein said controller is adapted to use rotor reference frame transformed variables.

21. The controller as claimed in claim 20 wherein said controller is adapted to quantify amount of PSOE.

22. The controller as claimed in claim 21 wherein said controller is adapted to provide an indication if the amount of PSOE exceeds a threshold.
